(19) United States
(12) Patent Application Publication
(10) Pub. No.: US 2009/0199325 A1
(43) Pub. Date: Aug. 13, 2009

(54) ACCESSORY ATTACHED TO A WEARABLE GARMENT

(76) Inventors: Michelle J. FUWAUSA, Columbia, MD (US); Michael F. Houtkin, Coral Springs, FL (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/370,949

(22) Filed: Feb. 13, 2009

Related U.S. Application Data
(60) Provisional application No. 61/028,201, filed on Feb. 13, 2008.

(51) Int. Cl. A41D 27/08; B67B 7/44

(52) U.S. Cl. 2/244; 81/3.09

(57) ABSTRACT

A wearable garment with a stitched or otherwise secured accessory, which is preferably a one piece PVC or injection moulded plastic accessory. The accessory includes a base for attachment to the garment and a disk in the general shape of a bottle cap and bottle flange. The disk is attached together with the base by a flexible tether. The base unit is glued, stitched or otherwise attached to the wearable garment and the, bottle cap shape, is snapped onto the base unit.

### RELATED APPLICATIONS

This application claims priority to provisional application Ser. No. 61/028,201 filed Feb. 13, 2008, entitled “PVC OR Plastic Attached TO A WEARABLE GARMENT” and incorporated herein by reference in its entirety.

### BACKGROUND OF THE INVENTION

a. Field of Invention

This invention relates generally to wearable garment incorporating a novel accessory preferably made of PVC (poly-vinyl chloride) or other plastic material. The accessory is sized and shaped so that it can be used as a bottle opener. A wearable garment with a stitched or appliqued plastic which could be injection molded plastic, in the general shape of a bottle cap, a separate plastic flange to fit or snap-on the plastic bottle cap shape, preferably in a flexible one-piece unit with a connecting sleeve or bridge. The molded plastic, or PVC, in the shape of a bottle cap, can be attached to any area of the wearable garment. The preferred positioning would be at the front of the lower left hand side of the wearable garment. The, bottle cap shape, can be separated from the base unit, but would still be connected with a sleeve or connecting cantilever bridge to the base unit which is attached to the wearable garment. The application can aesthetic and functional as the bottle cap shape would be preferably larger than an actual size bottle, produced for the consumer marketplace. The larger size would allow the plastic or PVC bottle cap to fit over an actual bottle cap and can be used to twist-off and/or as a bottle opener.

b. Description of the Prior Art

Many types of plastic or rubber articles have been made or proposed for wearable garments; see for example my U.S. Pat. No. 6,174,075 Illuminated Ornamentation/Amusement Device where an image or logo molded from PVC is placed on the surface of a hat and LED's are underneath placed underneath. Canadian Pat. No. 2327055, discloses an “Article for Clothing with Bottle Cap Gripping Patch”, that describes a protective patch or medallion affixed to an article of clothing use to facilitate the removal of a twist-off cap, Australian Pat. No. AU2005100026 A4, describes a “Bottle Opening Assembly”, having a hollow domed shape that is attached to a t-shirt for opening a bottle. These patents use a plastic or rubber affixed or secured to wearable apparel, including for instance shirts, hats, jackets backpacks or shoes. In the prior art an object made of PVC or plastic was completely attached to a wearable garment, and did not have a flexible connecting cantilever sleeve or joint allowing separation or even detachment from the attached base or garment.

### OBJECTIVES AND SUMMARY OF THE INVENTION

It is an objective to improve prior art through which a new assembly can be provided to display logos and other decorative elements and at the same time have the functional ability to remove a twist-off and/or flip-off bottle cap.

It is another objective that the new assembly for presenting original artwork, colors and application of the manufactures as provided on their original bottle cap.

It is another objective of the present invention to provide a a garment with an accessory made of a pliable soft plastic or PVC that provides easier access and extension of the of a bottle opener from the garment. The accessory also limits the spillage from a beverage and potential smell of alcohol and/or subsequent potential damage to the wearable garment.

The present invention pertains to a wearable garment with a stitched, sawn, glued or otherwise secured accessory, which is preferably made as a one-piece PVC or injection moulded plastic. The accessory includes a base for attachment to the garment and a disk in the general shape of a bottle cap. The disk is attached together with the base by a flexible tether. The base unit is glued, stitched or otherwise attached to the wearable garment and the, bottle cap shaped disk, is snapped onto the base unit. If possible, the, bottle cap removing and holding disk, and base are larger than the standard glass bottles used in the consumer marketplace where an actual size bottle cap with a logo or design could be attached to the top of the disk to in order to provide for aesthetical and/or for promotional purposes. The, bottle cap removing disk can be separated from the base unit, but still remains connected with a connecting strap or tether to the base which is attached to the wearable garment. The plastic or PVC accessory also functions to remove a twist off or flip off type bottle cap.

### BRIEF DESCRIPTION OF THE DRAWINGS

The invention will be better understood by reference to the following description, taken in connection with the appended drawings, in which the reference numerals indicate the parts, and in which,

FIG. 1 shows an article of clothing or garment with an accessory constructed in accordance with this invention;

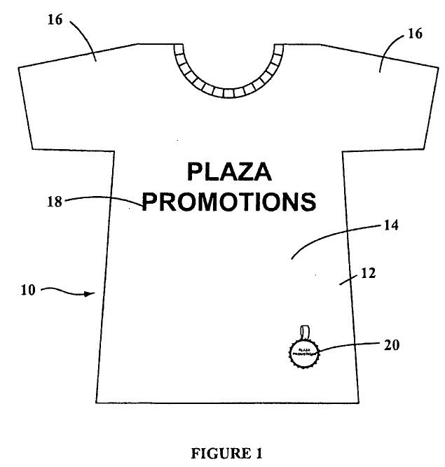

FIG. 2 shows a perspective exploded view of the accessory attached to the garment of FIG. 1;

FIG. 3 shows the close-up front view of the garment of FIG. 1 with the attached accessory of FIG. 2; and

FIG. 4 shows an O-ring inserted into the cap removing disk used for flip-off type bottle.

### DETAILED DESCRIPTION OF THE INVENTION

Referring now to the figures, a typical garment 10 such as a t-shirt 10 includes a body 12 with a front or chest area 14 and arms 16. The front area 14 may include or be provided with printed indicia 18.

Importantly, garment 10 is also provided with an accessory 20, the accessory 20 is preferably made of PVC or other plastic material, plastic in the shape of a bottle cap attached to the wearable garment. The accessory could be attached to the garment 10 by any well known means such as by machine stitching, gluing, or other chemical or heat processing.

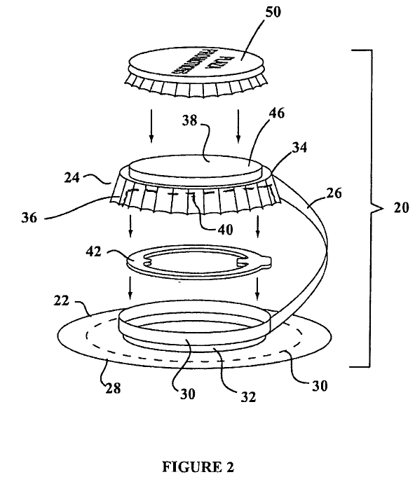

Referring to FIG. 2, accessory 20 includes a base 22, a disk 24 and a strap or tether 26 attaching the base 22 and the disk 24 to each other. Preferably base 22 is formed with a flat, preferably circular or annular plate 28. Plate 28 is made of a thin material so that it can be sewn to the garment, for example along line 30. Alternatively, if the accessory 20 is attached by other means, the plate can have a different shape. The plate 28 is formed with an annular crown 30 attached to the rest of the plate 22 by a neck 32 having a slightly reduced diameter.

Disk 24 has a cylindrical wall 34 which may be smooth, or may be formed with a plurality of axial grooves 36. The top surface 38 of disk 24 can be featureless or can be provided with some decorative indicia (not shown). At the bottom, the disk 24 is formed with an internal cavity 40. The cavity 40 is sized and shaped so that the disk 24 can be snapped onto and form an interference fit with crown 30. Importantly, both disk 24 is constructed and sized so that it can fit snuggly over the twist off cap of a bottle (not shown). An O-ring 42 may be provided inside the cavity 40 to reinforce it, if necessary.

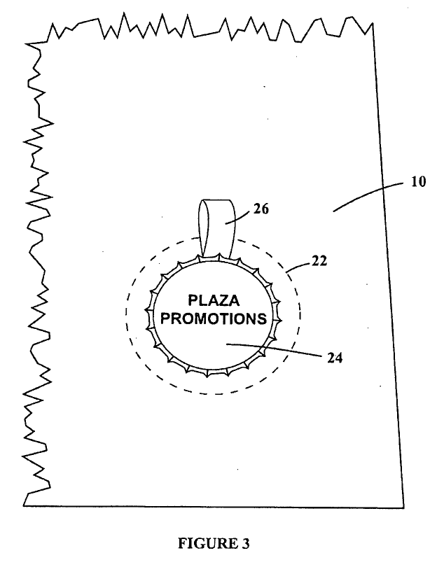

The strap 46 is made flexible enough to allow the disk 24 to be attached to, and remove from the crown 30. Normally, the garment 10 is worn with the disk 24 being attached to the base 22 as shown in FIG. 3. In this figure, the garment 10 is shown with the plate 28 disposed underneath the garment and protruding through a hole having the same dimension as neck 32. Of course, the plate 28 can also be attached to the top of the garment surface.

The wearer can decide to use the accessory 20 to open the twist-off cap of a bottle. For this purpose, he first removes or detaches the disk 24 from neck 30 and places it on the twist-off cap. He then grabs the disk 24 and uses it to twist the twist-off cap until the cap separates from the bottle.

In one embodiment, the twist off cap is discarded. In another embodiment, the surface 38 is formed with a boss 46. The boss 46 is sized and shaped to receive the twist-off cap 50 that has been removed from a bottle (not shown) and mounted on the boss 46. The cap 50 is then maintained in the disk by the interference fit between the boss 46 and cap 50 or by glue. In this manner, the cap 50 becomes part of the accessory 20. Of course, the user is free at any time to remove and discard cap 50 and use the disk 24 to remove the cap of another bottle.

In an alternate embodiment, the accessory 20 is provided or sold to users or customers with a cap 50.

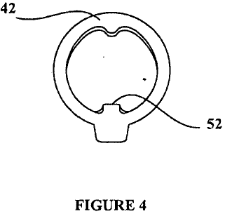

In another embodiment, the interior cavity 40 is sized and shaped to accept and remove a cap that is flipped off a bottle rather than a twisted off. For this purpose, the 0-ring 42 is formed with a radial extension or lip 52 shown in FIG. 4 that can be used to engage and remove the cap from a bottle of soda, beer or alcoholic beverage.

Preferably, the whole accessory 20 is formed as an integral piece from PVC or other plastic material by molding or other well known processes.

The subject garment assembly provides several advantages over the prior art. It provides an accessory that can be readily mounted on any part of the garment, although the lower right hand corner shown in the drawings is preferable. It provides plenty of display area for advertising and other informational material not only on the front the t-shirt but also on the accessory (e.g. surface 40). More importantly, the accessory can also be used to display the bottle cap top surface as the bottle cap rests and is engaged by the accessory. The strap or tether 26 allows a user to remove the cap of any appropriate bottle at will. Since the user can hold both the bottle and the accessory securely in his hand, the bottle can be opened without the fear of spilling its contents. The accessory can be easily designed to open either twist-off or flip-off bottle caps.

Other modifications may be made to this invention without departing from its scope as defined in the appended claims.

We claim:

1. A combined garment assembly comprising:
a wearable garment having a front surface; and
an accessory attached to the wearable garment and being arranged and constructed for removing bottle caps from bottles, said accessory including a base secured to the garment, a disk formed with a cavity sized and shaped to fit over the cap of a bottle to allow a user to remove the cap from the bottle; and a tether attaching the disk to the base.

2. The assembly of claim 1 wherein said base further includes a crown for selectively receiving and holding said disk when said disk is not in use.

3. The assembly of claim 1 wherein said disk is formed with a boss sized and shaped to receive an object and hold said object.

4. The assembly of claim 3 wherein said object is a bottle cap.

5. The assembly of claim 1 wherein said accessory is a molded integral element made of a plastic material.

6. The assembly of claim 1 wherein said disk is sized and shaped to remove a twist-off bottle cap.

7. The assembly of claim 1 wherein said disk is sized and shaped to remove a flip or snap top from the bottle.
